(19) United States
(12) Patent Application Publication
(10) Pub. No.: US 2025/0209850 A1
(43) Pub. Date: Jun. 26, 2025

(54) Origins Technology - Facial Feature Identification (OT-FFI)

(71) Applicant: Charles Wai Siu, Rosslyn, VA (US)

(72) Inventor: Charles Wai Siu, Rosslyn, VA (US)

(21) Appl. No.: 18/395,511

(22) Filed: Dec. 23, 2023

(51) Int. Cl. G06V 40/16

(52) U.S. Cl. CPC G06V 40/168; G06V 40/172

(57) ABSTRACT

Origins Technology—Facial Feature Identification (OT-FFI) is a new and innovative technology and method that enables you to identify the ethnic origins of the people of the world from images of the heads and faces of the individuals. Using facial recognition technology, OT-FFI creates a faceprint (numeric values corresponding to facial features) of an individual from images of his head and face. The Origins Technology Database (OTD) is a database of the faceprints of individuals around the world with their corresponding ethnic origins and towns of origin. The OTD groups individuals and their faceprints by their towns of origin and performs a computerized analysis on the faceprint data using the head and facial features of the individuals and the ethnic origins and towns of origin of the individuals. The OT-FFI technology and method then produces typical faceprints and facial features of the towns of origin with variations from the typical faceprints and features. OT-FFI takes the faceprint of an individual and compares the faceprint to the OTD to determine the likely ethnic origin and town of origin of the individual.

Origins Technology—Facial Feature Identification (OT-FFI) is a new and innovative technology and method that enables you to identify the ethnic origins of the people of the world. Using OT-FFI, the U.S. Federal government, state governments, companies, non-profit organizations and individuals will be able to identify the ethnic origins and towns of origin of individual Americans simply by having images of their heads and faces. When you meet someone in real life and look at their head and face, you intuitively have an idea of the ethnicity of the person and where the individual might be from. On a high level, you would say that person is either European, Asian, Latin American or African. If the person is European, you could further distinguish if he is from Northern Europe or Southern Europe. A Northern European from Sweden (with blonde hair and blue eyes) looks different than a Southern European from Italy (with brown hair and brown eyes). Within Northern Europe, you could further distinguish if the person was from Sweden, Germany or Great Britain if you had the right data on the head and facial features of the people from these countries.

OT-FFI computerizes and emulates the processes of your brain when you meet someone and you determine his ethnicity or where he might be from. On a high level, using images of an individual's head and face, OT-FFI would determine if the individual is European, Asian, Latin American or African. If OT-FFI determines the person is European (based on facial features like eye color, skin tone, hair color and nose shape), the technology would then make a more specific determination if he is from Northern Europe or Southern Europe. If OT-FFI determines that he is from Northern Europe, it would then use even more precise head and facial feature data to determine the country and town in Northern Europe the individual is from.

Ethnic groups around the world from the same geographic area have the same or similar head and facial features. Head features are head shape and hair color. Facial features are eye color, eye shape, ear shape, nose shape, mouth shape, jaw shape, cheek bone shape and skin tone. For example, Northern Europeans have similar head and facial features that are distinguishable from Southern Europeans. Northern Europeans have lighter eye color (blue, hazel), lighter skin tone (fair, light), lighter hair color (blonde, blondish brown), longer faces and sharper noses compared with Southern Europeans. Northern Europeans have lighter eye color, skin tone and hair color because their habitat of origin in Northern Europe is far from the Earth's equator, and they have evolutionarily received less exposure to sunlight that tends to darken the pigments of the eyes, skin and hair. In contrast, Southern Europeans have darker eye color, skin tone and hair color because their habitat of origin near the Mediterranean Sea is closer to the equator, and they have evolutionarily received more exposure to sunlight that has darken their eyes, skin and hair pigments.

Even Europeans from the same town within a region have distinguishable head and facial features compared with Europeans from other towns. This is because Europeans within the same town intermarry and interbreed with each other and propagate particular head and facial features within that town. This phenomenon is similar to Charles Darwin's observations about the evolution of different shapes and sizes of bird beaks on the Galapagos Island. When you identify the head and facial features of individuals, you are able to identify the ethnic origins and towns of origin of the individuals. Using OT-FFI, you are able to trace individuals' ethnic origins and towns of origin even with the migration of these individuals to other towns.

OT-FFI technology and method uses computerized image processing to identify the unique head and facial features of individuals because of their interbreeding within a specific geographic area. These unique external features are similar to the unique internal DNA genes that would be found for individuals within a certain geographic area. Because of interbreeding, you would find similar DNA genes for individuals within a town or region. The external physical manifestation of these similar internal DNA genes would be found in the head and facial features of these individuals. DNA testing for the same or similar DNA genes of individuals within a town would be expensive, complicated and take a long time. You could use DNA testing to find the similar genes for eye color, skin tones, hair color and other genetic traits for individuals within a particular European town and build a database of DNA genes for different towns in Europe. This process, however, would require you to obtain DNA samples of the individuals you wanted to test, and the testing process would be expensive and take a long time. By using OT-FFI to identify the physical manifestation of these DNA genes in the individual's head and facial features, you greatly increase the speed of identification at a much lower cost.

The use of OT-FFI technology and method for Europeans may be extrapolated to the United States. Although not always the case, Northern Europeans tend to settle in the Northern United States where the colder climate is similar to their towns of origin in Europe. For example, Americans of Scandinavian and German descent tend to settle in the upper Midwest in states like Minnesota and North Dakota. Similarly, Southern Europeans tend to settle in the Mid-Atlantic and Southern United States where the climate is warmer. Europeans from the same towns in Europe also tend to migrate to the same towns in the United States because of family and friend connections. For example, German and Irish immigrants often settle near each other in the same towns in the Midwest. You will find groups of Europeans with similar head and facial features within the same towns in the United States. Therefore, using OT-FFI, you are able to trace individual Americans back to their American towns of origin and their European towns of origin. Because Americans are more socially mobile and have historically migrated more often than Europeans, OT-FFI will be more accurate in determining an individual's European town of origin than their American town of origin. Generally, OT-FFI will be more successful in determining an individual's town of origin for countries and ethnic groups with lower social mobility and migration patterns. Traditional towns in Europe with rigid social structures and less migration will have more defined and distinguishable head and facial features compared with large metropolises in America with high social mobility and population migration.

In addition to Europeans, OT-FFI technology and method may also be used for Asians, Latin Americans, Africans and all other ethnic groups in the world. For example, Northern Asians have head and facial features that are distinguishable from Southern Asians. Northern Asians have lighter eye color, hair color and skin tone than Southern Asians because their habitat of origin in Northern Asian is further from the equator and sunlight. Northern Asians also have longer faces compared with the rounder faces of Southern Asians. When you meet an Asian from Northern Asia like a Northern Chinese, Korean or Japanese, he will look different than an Asian from Southern Asia like a Southern Chinese, Taiwanese, Malaysian or Filipino. Asians from the same town within a region also have similar head and facial features because of intermarriage and interbreeding within that town. Therefore, using OT-FFI technology and method, you are also able to trace Asians back to their Asian ethnic origins and their Asian towns of origin.

OT-FFI technology is useful for genealogy, academic research, employment, artificial intelligence, entertainment, law enforcement and government intelligence. By creating a database of head and facial features, ethnic origins and towns of origin, you will be able to identify the head and facial features of every ethnic group in the world. Using OT-FFI technology and method, you will be able to determine the ethnic origin and town of origin of an individual from images of his head and face.

### Existing Facial Recognition Technology

U.S. Federal agencies, state agencies and companies use existing Facial Recognition Technology (FRT) to match the image of an individual's facial features to a database of images to determine the identity of an individual. The parameters of existing facial recognition technology is for one-to-one comparisons of an individual's facial features to a database of images. The Facial Recognition System (FRS) takes an image or video capture of an individual's face and performs a computerized analysis of the face. The computer program (using a photometric recognition algorithm) takes the facial features of the individual and gives each facial feature a numeric value corresponding to the magnitude of the feature. The faceprint is the list of numeric values for the individual's face that determines the facial identity of the individual. The faceprint is then processed through a search of a database of faceprints to try to match the individual to somebody already in the database and thereby determine his identity. The existing FRT technology, therefore, is only a database of individuals' facial features that is searchable when an individual needs to be compared to individuals in the database. There is no analysis of the faceprints and facial features of the individuals in the database.

### Origins Technology Database (OTD)

OT-FFI technology and method start with a database that is similar to existing FRT technology that accumulates the head and facial features of individuals and quantifies the features into numeric value faceprints that are stored in the Origins Technology Database (OTD). In addition to the faceprint data, the database would also record the ethnic origins and towns of origin of the individuals. Ethnic and towns of origin information would be obtained from available passport and birth certificate information. What differentiates the OT-FFI from the existing facial recognition technology is that a computerized analysis would be performed on the faceprint data using the head and facial features of the individuals and the ethnic origins and towns of origin of the individuals. Once sufficient data is accumulated for a European town, the OT-FFI would produce typical faceprints and facial features of the European town with variations from the typical faceprints and features. Ethnic faceprints would be produced for each European town and for every town in each country in the world.

The Origins Technology Database (OTD) will be created using head and face images from existing head and face image databases from social media platforms like Facebook and LinkedIn, the U.S. Department of State's passport picture database, state driver's license databases and foreign countries' passport and personal identification databases. Each individual's record will contain the following fields: name, faceprint (facial feature numeric values), ethnicity, nationality, place of birth and every known address. The ethnicity field would be selected from one of these values: European, Asian, Latin American, African or Mixed Race. As the OTD develops with more data, the hometown of origin will be added to the database. Existing facial recognition technology will be used to quantify each individual's facial features into faceprint numeric values. The faceprint field will have the following subfields: eye color, eye shape, skin tone, hair color, ear shape, nose shape, mouth shape, cheek bone shape, jaw shape and head shape.

### APPLICATIONS OF OT-FFI

For genealogy purposes, a genealogy company would be able to take images of their members and use OT-FFI to provide them with their ethnic origins and likely towns of origin based on their faceprints. OT-FFI information supplements the DNA testing and document records research an individual would perform in researching his genealogy and family history. The genealogy company would also be able to provide its members with a list of other members and people who look like them (look-a-likes) and may be related to them.

For social media purposes, social media platforms would be able to use OT-FFI to take their members' pictures and provide them with their ethnic origins and likely towns of origin. OT-FFI information would have both educational and entertainment value. The social media platform would also be able to provide its members with a list of other members who look like them (look-a-likes) and who may be related to them.

For artificial intelligence purposes, technology companies using artificial intelligence software would be able to integrate OT-FFI into their artificial intelligence software. These companies would be able to use OT-FFI and artificial intelligence to determine the nationality and ethnic origins of their customers and customize their companies' services to their customers based on their nationality and ethnic origins that would take into account the customs and traditions of these individuals. For example, if OT-FFI determines a person to be from Italy in Southern Europe instead of from Asia, Latin America or African, the artificial intelligence program might make recommendations for Italian food, drinks and fashion based on what is trending in Italian culture.

Government agencies would use OT-FFI for image or video captures of individuals' heads and faces. Even if the individuals are not in the government agencies' existing database of images, OT-FFI would be able to determine the likely ethnic origins and towns of origin of the individuals from their head and facial features. The individuals' towns of origin would then be useful information to the government agencies for their investigative purposes. Skilled government agents with knowledge about the facial features of the peoples of the world would be able to examine images of individuals and make analyses of the likely ethnic origins of the individuals. OT-FFI computerizes and automates the brain processes of skilled government agents in making the analyses of the ethnic origins of individuals based on images of the individuals. OT-FFI would also be used to determine likely relatives of the individuals based on the individuals' head and facial features. Lists of likely relatives would also be useful to the government agencies for their investigative purposes.

What is claimed is:

1. A method that uses computerized processes and facial recognition technology to determine the ethnic origin of an individual from images of the head and face of the individual. Using facial recognition technology, Origins Technology—Facial Feature Identification (OT-FFI) creates a faceprint (numeric values corresponding to facial features) of an individual from images of his head and face. These facial features are eye color, eye shape, skin tone, hair color, ear shape, nose shape, mouth shape, cheek bone shape, jaw shape and head shape.

2. The Origins Technology Database (OTD) is a database of the faceprints of individuals around the world with their corresponding ethnic origins and towns of origin. The OTD groups individuals and their faceprints by their towns of origins and performs computerized analyses on the faceprint data that takes into account the head and facial features of the individuals and the ethnic origins and towns of origin of the individuals. OT-FFI technology and method then produces typical faceprints and facial features of the towns of origin with variations from the typical faceprints and features.

3. OT-FFI takes the faceprint of an individual and compares the faceprint to the OTD to determine the likely ethnic origin and town of origin of the individual. OT-FFI takes the faceprint of an individual and searches the OTD to find look-a-likes (other individuals who look similar to the individual) and possible relatives of the individual. OT-FFI technology is useful for genealogy, academic research, employment, social media, artificial intelligence, entertainment, law enforcement and government intelligence. For genealogy purposes, a genealogy company would be able to use OT-FFI for their members to establish their ethnic origins and likely towns of origin from images of their heads and faces. They would also be able to provide their members with look-a-likes and other members who might be related to them. For social media purposes, a social media company would be able to use OT-FFI to provide their members with their ethnic origins and likely towns of origin from images of their heads and faces. They would also be able to provide their members with look-a-likes and other members who might be related to them. For artificial intelligence purposes, a technology company would be able to use OT-FFI with their artificial intelligence program to establish their customers' nationality and ethnic origins and customize their services to the culture of their customers. For government agency purposes, government agencies would be able to use OT-FFI to discover the likely ethnic origins and towns of origin of individuals from images of their heads and faces with individuals that are not currently in the agency's existing facial recognition database. They would also be able to use OT-FFI to make lists of likely relatives of the individuals. The ethnic origins, towns of origin and lists of likely relatives would be useful information to the government agency for their investigative purposes.
